(19) United States
(12) Patent Application Publication
(10) Pub. No.: US 2011/0018474 A1
(43) Pub. Date: Jan. 27, 2011

(54) ELECTROMECHANICAL SYSTEM HAVING A VARIABLE FREQUENCY DRIVE POWER SUPPLY FOR 3-PHASE AND 1-PHASE MOTORS

(75) Inventors: Warren Harhay, Boulder City, NV (US); Paul Sarkisian, Boulder City, NV (US)

Correspondence Address: KNOBBE MARTENS OLSON & BEAR LLP, 2040 MAIN STREET, FOURTEENTH FLOOR, IRVINE, CA, 92614, US

(73) Assignee: ROCKY RESEARCH, Boulder City, NV (US)

(21) Appl. No.: 12/510,147

(22) Filed: Jul. 27, 2009

(51) Int. Cl. H02P 5/00

(52) U.S. Cl. 318/82

(57) ABSTRACT

An electromechanical system is configured with a variable frequency drive power supply which provides power to both a three-phase motor and to a single-phase motor. In some embodiments, the variable frequency drive also powers one or more additional motors.

### BACKGROUND

In many electromechanical systems, variable speed drives, commonly referred to as variable frequency drives (VFD), are used to more efficiently operate and provide power to motors. For example, VFDs may be used in pumping systems, elevators, conveyor systems, transport systems, and heating, ventilation, air conditioning, and refrigeration (HVAC/R) compressor and/or fan motors. Such electromechanical systems include at least one three-phase motor and at least one single-phase motor which operate together, at the same time. It is, therefore, desirable that the three-phase motor and the single-phase motor are powered from the same power supply. However, single-phase motors are considered incompatible with the power output from a VFD. Consequently, it is the present practice to use a three-phase motor where a single-phase motor would suffice or to power the single-phase motor with a separate power supply. Either practice, although common, increases the cost of the system.

### SUMMARY OF THE INVENTION

Described herein is an electromechanical system, including a three-phase motor, a single-phase motor, and a variable frequency drive inverter power supply (VFD), configured to generate a three-phase output for the three-phase motor and for the single-phase motor. In some embodiments, a phase change module is connected between the VFD and the single-phase motor.

In some embodiments, a method of configuring an electromechanical system includes connecting a variable frequency drive inverter (VFD) to a power source, the VFD configured to generate a power output having three phases, connecting a three-phase device of the electromechanical system to the power output, and connecting a single-phase device of the electromechanical system to the power output.

In some embodiments, a method of configuring power for operating an electromechanical system with a variable frequency drive inverter (VFD), includes supplying power to the VFD. The VFD is configured to generate a power output having three phases. The method also includes supplying power from the power output of the VFD to a three-phase device, and supplying power from the power output of the VFD to a single-phase device.

### BRIEF DESCRIPTION OF THE DRAWINGS

FIG. 1 is a schematic block diagram illustrating an electromechanical system according to one embodiment;

FIG. 2 is a schematic diagram illustrating an embodiment of a phase change module;

FIG. 3 is a block diagram illustrating an electromechanical system according to one embodiment; and

FIG. 4 is a schematic block diagram illustrating a conventional electromechanical system.

### DETAILED DESCRIPTION

The power supply system for an electromechanical system may be configured, such that, rather than receiving power directly from an AC utility source, the electromechanical system components receive power from one or more power supplies, such as a VFD, which receives power from a DC bus. In the system, the DC power bus may receive power from, for example, the AC utility source through a rectifier. The DC power bus is used to provide power to one or more power supplies which generate appropriate AC power for the electromechanical system components. For example, VFDs may be used in pumping systems, elevators, conveyor systems, transport systems, and HVAC/R compressor and/or fan motors.

In some electromechanical systems a three-phase motor and a single-phase motor operate at the same time. In order to reduce the total number of power supplies, the three-phase motor and the single-phase motor are advantageously driven with the same power supply. In addition, at least because of power efficiency at start up of the three-phase motor, a variable frequency drive power supply (VFD) is desirable. A VFD chops the DC voltage from the DC power bus into three outputs 120 degrees out of phase, which the motors driven see as AC. The system has speed control and the range of the speed control is unlimited for the one or more 3-phase motors and is limited at the low end of the range for the one or more 1-phase motors. While the discussion herein is generally directed to a system having a three-phase motor and a single-phase motor, it is to be understood that the discussion applies to systems having one or more three-phase motors and one or more single-phase motors driven with the same power supply.

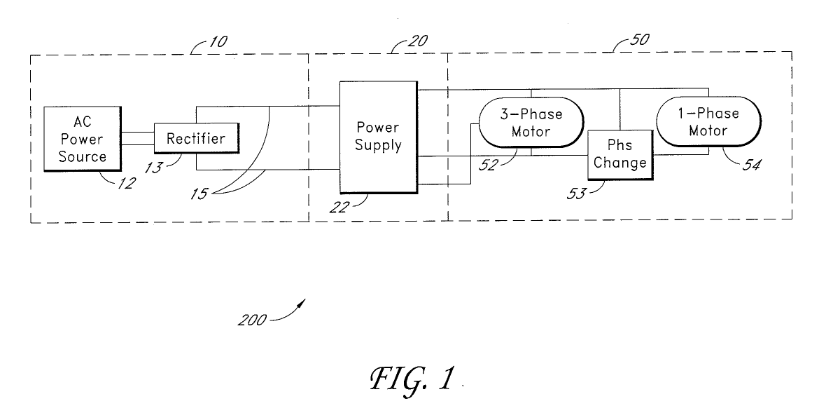

FIG. 1 is a diagram of an embodiment of an electromechanical system. The electromechanical system 200 includes a power source section 10, a power supply section 20, and a system component section 50. The power source section 10 includes one or more power sources which provide power for the components of the system 200. The power supply section 20 includes one or more power supplies which receive power from the power source section 10 and provide the power to the components of the system component section 50. The components of the system component section 50 perform functions of the electromechanical system.

In the embodiment of FIG. 1, the power source section 10 includes a first power source 12, a rectifier 13, and a power bus 15. In this embodiment, the first power source 12 is an AC power source and provides power to the rectifier 13, which provides substantially DC power to the power bus 15. In alternative embodiments, the first power source 12 may be a DC power source, which provides DC power to the power bus 15. Accordingly, in such embodiments, the rectifier 13 is omitted. In some embodiments, a second power source is also configured to provide power to the power bus 15.

Power source 12 may be any type of power source. In the embodiment of FIG. 1, power source 12 is an AC power source. Power source 12, for example, may be an AC mains, such as that provided by the local power company. Power source 12 may have, for example, one or three phases. In some embodiments, power source 12 is a three-phase, about 240V, AC source. Other power sources include a solar or wind power generator.

Rectifier 13 is configured to receive AC power from the first power supply 13, to rectify the power signal to a substantially DC level, and to provide the DC level to the power bus 15.

The optional second power source may be a secondary or back-up power source, for example, a battery or a battery pack, configured to be charged and recharged. Other types of energy storage devices may also be used. The second power source is connected to the power bus 15, and is configured to be charged by the power bus 15 when the first power source 12 is functioning and the second power source is not fully charged. The second power source is further configured to provide power to the power bus 15 when the power from the rectifier 13 or the first power source 12 is insufficient for the load on the power bus 15.

The power supply section 20 includes a power supply 22, which receives power from the power source section 10 via power bus 15 and provides the power for use by the components of the system component section 50. In the embodiment of FIG. 1, there is one power supply 22. In other embodiments, more power supplies are used.

In this embodiment, power supply 22 is configured to supply power to two motors: three-phase motor 52 and single-phase motor 54. Although shown separately, rectifier 13 may be integrated with power supply 22.

In one embodiment, power supply 22 is a variable frequency drive power supply (VFD). In some embodiments, the VFD comprises the power supply 22 and the rectifier 13. A VFD may be used to achieve speed control of the motors driven. Additionally or alternatively, VFD may be used because of increased power efficiency achieved through controlled start up of the three-phase motor 52. When a constant frequency and voltage power supply, such as an AC mains power supply, is used, inrush current to start a motor may be six to ten times the running current. Because of system inertia, the three-phase motor is not powerful enough to instantaneously drive the load at full speed in response to the high frequency and high speed signal of the power supply signal needed at full-speed operation. The result is that the motor goes through a start-up phase where the motor slowly and inefficiently transitions from a stopped state to full speed. During start up, some motors draw at least 300% of their rated current while producing less than 50% of their rated torque. As the load of the motor accelerates, the available torque drops and then rises to a peak while the current remains very high until the motor approaches full speed. The high current wastes power and degrades the motor. As a result, overall efficiency, effectiveness, and lifetime of the motor are reduced.

When a VFD is used to start a motor, a low frequency, low voltage power signal is initially applied to the motor. The frequency may be about 2 Hz or less. Starting at such a low frequency allows the load to be driven within the capability of the motor, and avoids the high inrush current that occurs at start up with the constant frequency and voltage power supply. The VFD is used to increase the frequency and voltage with a programmable time profile which keeps the acceleration of the load within the capability of the motor. As a result, the load is accelerated without drawing excessive current. This starting method allows a motor to develop about 150% of its rated torque while drawing only 50% of its rated current. As a result, the VFD allows for reduced motor starting current from the AC power source 12, reducing operational costs, placing less mechanical stress on the three-phase motor 52, and increasing service life. The VFD also allows for programmable control of acceleration and deceleration of the load.

The VFD of power supply 22 produces a three-phase output, which powers the three-phase motor 52. The three-phase motor 52 has rotational symmetry of rotating magnetic fields such that an armature is magnetized and torque is developed. By controlling the voltage and frequency of the three-phase power signal, the speed of the motor is controlled whereby the proper amount of energy enters the motor windings so as to operate the motor efficiently while meeting the demand of the accelerating load. Electrical motive is generated by switching electronic components to derive a voltage waveform which, when averaged by the inductance of the motor, becomes the sinusoidal current waveform for the motor to operate with the desired speed and torque. The controlled start up of three-phase motor 52 described above allows for high power efficiency and long life of three-phase motor 52.

Use of a VFD to power a motor allows for speed control, removing the limitation on the system to be either fully on or off. For example, an HVAC/R system with a VFD can operate the compressor at a speed corresponding to the cooling requirements of the environment having its temperature controlled. For example, if the controlled environment generates 500 watts of power, the compressor can be operated at a speed that corresponds to the heat generated by the 500 watts. This allows for improved power efficiency in the system because power inefficiencies experienced with repeatedly starting and stopping the compressor is avoided.

Furthermore, in some systems the load on motor is relatively constant. For example, for some HVAC/R applications, in controlled environments, such as well insulated spaces, the heat generated is relatively constant. Accordingly, the energy to be removed is relatively constant. For such environments, the compressor motor may be designed for operation according to the load corresponding to the relatively constant energy to be removed. Such limited range of load allows for the compressor to be efficiently operated.

Another benefit to speed control is that control of the motors function is increased. For example, in an HVAC/R system, the range of temperatures in a controlled environment is dramatically reduced when compared to conventional HVAC/R systems in which the compressor is either fully on or off. In conventional HVAC/R systems, in order to prevent frequent state changes between off and on, the control system works with a hysteresis characteristic. In such systems, temperature excursions correspond to the hysteresis. For example, in some systems the hysteresis of the system is 3 degrees. If the temperature is set to −5 C, once the temperature of the environment is −5 C, the compressor is turned off. However, because of the 3 degrees of hysteresis, the compressor will not be turned on again until the temperature of the environment is −2 C. In contrast, in an HVAC/R system with a VFD controlling the compressor, the active control system incrementally increases and decreases the speed of the compressor to provide precise control of the temperature in the environment. As a result, there is no hysteresis, and, accordingly, significantly reduced trade-off between consistency of temperature and power consumption.

In the embodiment shown, because the single-phase motor 54 does not operate without the three-phase motor 52, the three-phase output of power supply 22 can additionally power the single-phase motor 54. The result is beneficial system cost savings by eliminating a power supply dedicated to the single-phase motor 54.

In conventional electromechanical systems, when a VFD is used with a system having a three-phase motor and a single-phase motor which operate at the same time. The single-phase motor is either operated with a separate power supply or is replaced with a three-phase motor compatible with the output of the VFD power supply. In the system described and shown herein, because the single-phase motor 54 is advantageously driven by power supply 22, a less expensive single-phase motor is used. In order to allow the single-phase motor 54 to be driven with the power supply 22, the output of power supply 22 is conditioned by phase change module 53. For reasons similar to those described above with regard to power supply 22 comprising a VFD to efficiently turn on compressor motor 52, the system may include one or more additional VFDs configured to efficiently turn on and turn off one or more additional components of the system.

As shown in FIG. 1, phase change module 53 is connected between the VFD power supply 22 and single-phase motor 54. Single-phase motors such as single-phase motor 54 are not generally compatible with variable frequency and voltage operation. In single-phase motors, a “new” phase is generated to be used with the single phase of the input power signal to create rotating magnetism to the armature to generate torque. For example, if the single-phase motor is a shaded pole motor, a shading ring serves as an inductance capable of storing a magnetic field and generating the “new” phase. If the single-phase motor is a permanent split capacitor motor, a capacitor provides a phase lead of current to one terminal relative to another. The power efficiency of the shading ring and the capacitor, however, is frequency dependent, and therefore these elements are tuned to the running frequency of the motor according to its application. At non-specified frequencies, the behavior of the motor and that of the new phase generating elements are inefficient and the motor torque suffers. In addition, the power output signal of the VFD has large transient voltage spikes at high frequencies (e.g. 2-6 KHz). These transients can exceed the brake down voltage of the new phase generating elements, and cause high current spikes which increase heat and reduce power efficiency of the motor and its components. Therefore, these motors are ineffective for use in a variable frequency drive scheme.

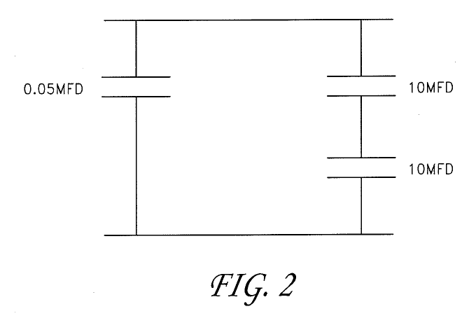

However, the single-phase motor 54 is modified to operate efficiently in the variable frequency drive scheme of FIG. 1. The single-phase motor 54 is similar to a three-phase motor where the first two poles carry the single phase of the power input, and the third pole receives the new phase generated by the inductive and capacitive elements. In electromechanical system 200, the single-phase motor 54 receives two of the three phases generated by the power supply 22. In addition, the modified single-phase motor has its new phase generation elements replaced with elements which are compatible with the large transient voltage spikes of the VFD, such as those shown in FIG. 2. In one embodiment of phase change circuit 53, the modification of the single-phase motor includes replacing the run capacitor with two capacitors of twice the capacitance, in series. This increases the breakdown voltage while keeping the capacitance value, and therefore the tuning of the motor, unchanged. These capacitors are shown as 10 MFD capacitors in FIG. 2. In addition, a capacitor with a ceramic composition and value in the range of 0.01 to 0.1 MFD placed in parallel with the two run capacitors, also shown in FIG. 2, provides lower impedance to the high frequency switching transients created by the VFD. For example, in a single-phase motor a main winding may be in parallel with a series connected 5 MFD run capacitor and auxiliary winding. The 5 MFD run capacitor may be replaced with two series connected 10 MFD capacitors in parallel with a 0.05 MFD capacitor, as shown in FIG. 2. In addition to allowing the single-phase motor 54 to be driven by the VFD 22, the phase change circuit 53 allows the speed of the single-phase motor 54 to be controlled by the VFD.

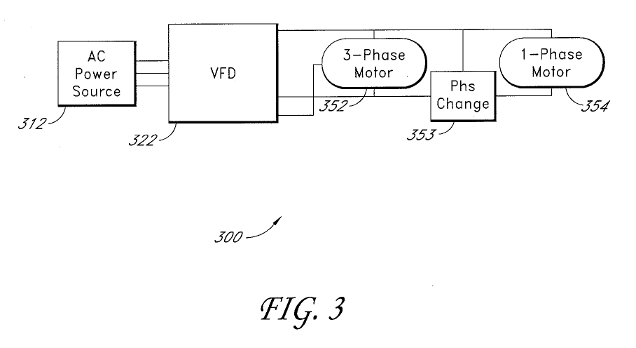

In some embodiments, electromechanical system 200 is implemented as shown in electromechanical system 300, shown in FIG. 3. In this embodiment, the rectifier 13 of FIG. 1 is included in the VFD power supply 322 of FIG. 3. An AC power source 312, which may be similar to AC power source 12 of FIG. 1, drives the VFD 322, which generates a substantially DC voltage for its own operation. In some embodiments, the DC voltage may drive a DC power bus (not shown) for other components of the system. VFD 322 may have similar functionality as power supply 22 of FIG. 1. The other components shown in FIG. 3, three-phase motor 352, phase change circuit 353, and single-phase motor 354, may each have similar functionality to the corresponding components shown in FIG. 1, three-phase motor 52, phase change circuit 53, and single-phase motor 54, respectively.

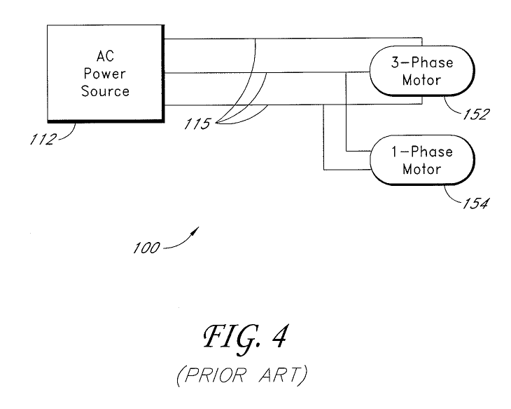

An existing electromechanical system may be converted to function similarly to or identically to electromechanical system 200. For example, prior art electromechanical system 100 shown in FIG. 4 may be converted to operate and achieve the advantages previously described. To convert electromechanical system 100, as shown in FIG. 4, and operate and achieve the advantages previously described, AC power source 112, three-phase motor 152, and single-phase motor 154 are disconnected from power bus 115. Referring also to FIG. 1, AC power source 112 is connected to power a power bus, such as power bus 15 with a rectifier, such as rectifier 13. A power supply, such as power supply 22, is connected to the power bus, to three-phase motor 152, and to single-phase motor 154. A phase change circuit, such as phase change module 53, is connected between the first power supply and the single-phase motor 154.

While the above detailed description has shown, described, and pointed out novel features as applied to various embodiments, it will be understood that various omissions, substitutions, and changes in the form and details of the devices and processes illustrated may be made by those skilled in the art without departing from the spirit of the invention. For example, inputs, outputs, and signals are given by example only. As will be recognized, the present invention may be embodied within a form that does not provide all of the features and benefits set forth herein, as some features may be used or practiced separately from others. Moreover, it is to be understood that the electromechanical systems described herein may be configured as air conditioners, chillers, heat pumps and refrigeration systems, but are not limited thereto.

What is claimed is:

1. An electromechanical system, comprising:
a three-phase motor;
a single-phase motor; and
a variable frequency drive inverter power supply (VFD), configured to generate a three-phase output for the three-phase motor and for the single-phase motor.

2. The electromechanical system of claim 1, wherein the single-phase motor comprises a permanent split capacitor (PSC) motor.

3. The electromechanical system of claim 2, further comprising a phase change module connected between the VFD and the PSC motor, the phase change module comprising a plurality of series capacitors and a parallel capacitor in parallel with the series capacitors.

4. The electromechanical system of claim 3, wherein the PSC motor further comprises a winding in series with the combination of the plurality of series capacitors and the parallel capacitor.

5. The electromechanical system of claim 1, further comprising a phase change module configured to condition the three-phase power output for the single-phase motor.

6. The electromechanical system of claim 5, wherein the phase change module comprises a plurality of series capacitors.

7. The electromechanical system of claim 6, wherein the phase change module further comprises a bypass capacitor in parallel with the series capacitors.

8. The electromechanical system of claim 1, further comprising one or more additional motors, wherein the VFD is configured to generate a three-phase output for the additional motors.

9. The electromechanical system of claim 1, further comprising first and second power sources, wherein the second power source is configured to increase power output to the power bus as a result of a reduction in power output to the power bus from the first power source, wherein the three-phase output of the VFD remains substantially uninterrupted.

10. The electromechanical system of claim 1, further comprising one or more additional three-phase motors, wherein the VFD is configured to generate a three-phase output for the additional three-phase motors.

11. The electromechanical system of claim 1, further comprising one or more additional single-phase motors, wherein the VFD is configured to generate a three-phase for the additional single-phase motors.

12. The electromechanical system of claim 10, further comprising one or more additional single-phase motors, wherein the VFD is configured to generate a three-phase for the additional single-phase motors.

13. The electromechanical system of claim 1, further comprising one or more additional VFDs configured to supply power to one or more additional components of the system.

14. A method of configuring an electromechanical system, the method comprising:
connecting a variable frequency drive inverter (VFD) to a power source, the VFD configured to generate a power output having three phases;
connecting a three-phase device of the electromechanical system to the power output; and
connecting a single-phase device of the electromechanical system to the power output.

15. The method of claim 14, wherein the three-phase device is a three-phase motor and the single-phase device is a single-phase motor.

16. The method of claim 15, wherein the single-phase motor comprises a permanent split capacitor (PSC) motor.

17. The method of claim 16, wherein the PSC motor comprises a plurality of series capacitors and a parallel capacitor in parallel with the series capacitors.

18. The method of claim 14, further comprising connecting a phase change module between the VFD and the single-phase device, wherein the phase change module is configured to condition the three-phase power output for the single-phase device.

19. The method of claim 18, wherein the phase change module comprises a plurality of series capacitors.

20. The method of claim 19, wherein the phase change module further comprises a bypass capacitor in parallel with the series capacitors.

21. A method of configuring power for operating an Electromechanical system, provided with a variable frequency drive inverter (VFD), the method comprising:
supplying power to the VFD, the VFD configured to generate a power output having three phases;
supplying power from the power output of the VFD to a three-phase device; and
supplying power from the power output of the VFD to a single-phase device.

22. The method of claim 21, wherein the three-phase device is a three-phase motor and the single-phase device is a single-phase motor.

23. The method of claim 22, wherein the single-phase motor comprises a permanent split capacitor (PSC) motor.

24. The method of claim 23, wherein the PSC motor comprises a run capacitor in series with a winding of the PSC motor comprises a plurality of series capacitors and a parallel capacitor in parallel with the series capacitors.

25. The method of claim 21, further comprising conditioning the three-phase power output for the single-phase motor with a phase change module.

26. The method of claim 25, wherein the phase change module comprises a plurality of series capacitors.

27. The method of claim 26, wherein the phase change module further comprises a bypass capacitor in parallel with the series capacitors.
